(19) United States
(12) Patent Application Publication
(10) Pub. No.: US 2001/0018355 A1
(43) Pub. Date: Aug. 30, 2001

(54) Method of transferring melodic information to a terminal

(75) Inventor: David P. Walker, Redhill (GB)

Correspondence Address: Michael E. Marion, U.S. Philips Corporation, Corporate Patent Counsel, 580 White Plains Road, Tarrytown, NY, 10591, US

(73) Assignee: U.S. PHILIPS CORPORATION

(21) Appl. No.: 09/780,736

(22) Filed: Feb. 9, 2001

(30) Foreign Application Priority Data
Feb. 25, 2000 (GB) 0004538.5

(51) Int. Cl. H04M 1/00

(52) U.S. Cl. 455/567; 455/419

(57) ABSTRACT

A method of entering melodic information into a terminal (SS1) having an audio capability, such as a portable telephone having a ringer (34), in which the information is entered as an unstructured character string of ASCII characters. Each byte of 4 characters comprises 2 characters representing a note and 2 characters representing a duration of that note. The information may be entered using a keypad (28) on the terminal or over the air from a remote terminal (PS). Short form methods are disclosed for handling repeat sequences of notes and their durations. Optionally a volume indicator may be included in the unstructured character string for use in setting the relative volume of the reproduced melodic information.

The present invention relates to a method of transferring melodic information to a terminal, particularly but not exclusively, to a portable wireless terminal such as a mobile telephone or a pager.

Currently mobile telephones use musical sequences as alerts. It is known for a manufacturer to pre-programme such sequences into a mobile telephone during its manufacture. A user then chooses one of the preprogrammed musical sequences as his alert which means that the same sequence will be played each time a signal addressed to that mobile telephone is received. In the event of a user tiring of the currently used sequence, he can exchange it for another of the pre-programmed sequences.

WO92/03891 discloses a selective call receiver in which a user can program manually his/her own melody note by note into the receiver. The creation of the melody may be done using two keys provided on the receiver or by an external programming computer.

WO99/34340 discloses generating alert melodies using for example numeric data in an incoming paging message. The digits in the numeric data, say the telephone number of the party originating the message, are divided into one or two digit fields from which can be determined tempo, number of repeats, notes and beat durations which are expressed as multiples of a basic beat duration. Using this method the user of a selective call receiver can determine the identity of the originating party from the musical sequence played.

Several methods are known for storing data on a computer so that it can be reproduced in printed form. However such methods require the transmission and storage of relative long unstructured character strings. Such long character strings if transmitted over the air will require a wide bandwidth and will be prone to errors. Also they will require relatively complex decoding.

An object of the present invention is to be able to transmit melodic information from one station to another in an efficient manner.

According to one aspect of the present invention there is provided a method of entering melodic information into a terminal having an audio capability, comprising entering the information as a string of characters representing notes and their respective durations.

According to a second aspect of the present invention there is provided a terminal including means providing an audio capability and storage means for storing melodic information as a string of characters representing notes and their respective durations.

The method in accordance with the present invention enables melodic information to be entered manually using a keypad on the terminal or to be transmitted over the air as a narrowband signal which can be recovered by a relatively simple decoding operation requiring low power which is of benefit in a cordless, battery powered terminal.

In an implementation of the method in accordance with the present invention a note and its duration are encoded using an equal number of characters which are concatenated to form a byte. The characters may be ASCII characters.

One method of reducing the amount of data to be entered or transmitted is to use a short form method of entering or sending a repeating sequence of notes and of entering or sending repeated sequences of notes. In an embodiment of the present invention the short form method of entering or sending a repeating sequence of notes is by inserting an escape character, for example a punctuation mark such as a comma, into the character string after the last of the notes to be repeated and its duration and by inserting characters representing the number of repeats and characters representing the offset note back into the melody. In the case of wanting to repeat, repeating sequences, the short form is to insert an escape character, such as a comma, after the repeating sequence. By standardising on the number of repeats of repeating sequences, for example 4, it is unnecessary to include characters indicating the number of repeats.

A note may be indicated digitally by a pair of characters selected from a predetermined range of pairs of characters. Pairs of characters not included in the predetermined range may serve other applications such as indicating a silence or selecting one of a plurality of melodies previously stored, say at the manufacturing stage, by the terminal.

In the event of a terminal having a dynamic volume capability, the relative volume to be used when reproducing the string of characters may be predetermined by including a volume indicator in the string. The volume indicator may comprise an escape character, such as a comma, followed by a two digit indicator, for example a number between 01 and 10 representing the volume setting. In an alternative arrangement the volume indicator may comprise a non pre-allocated two digit number, say 01, indicative that the byte is a volume indicator and another two digits indicative of the volume setting.

The present invention will now be described, by way of example, with reference to the accompanying drawing, wherein:

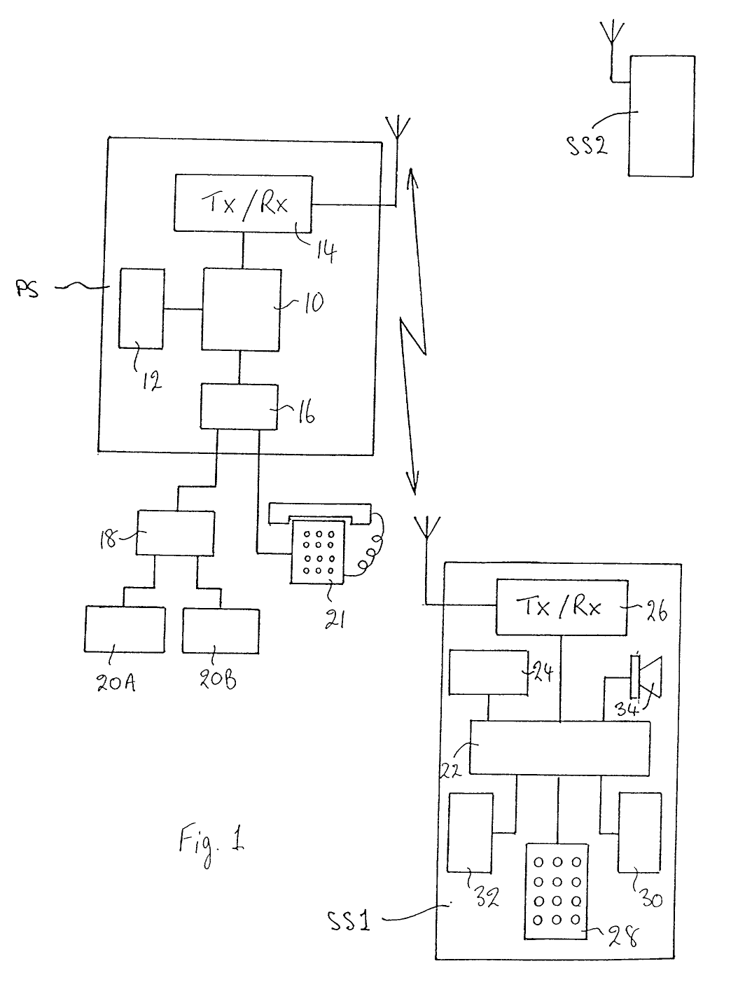

FIG. 1 is a block schematic diagram of a cellular/cordless communications system.

The cellular/cordless communications system shown in FIG. 1, comprises a primary station PS and a plurality of secondary stations SS1, SS2 which are able to roam within the radio coverage area of the primary station. As the present invention is concerned with relaying melodic information from say the primary station PS to a preselected secondary station SS1, SS2 as a point-to-point message, no discussion will be included relating the normal usage of the system for conveying speech or of the various protocols, such as GSM (Global System for Mobile Communications), DECT (Digitally Enhanced Cordless Telephone) and IS95, a spread spectrum standard applicable in the USA.

An extension of speech cellular/cordless telephone systems is in the area of e-mail services whereby a user with a portable telephone can interrogate an e-mail system to recover messages intended for a user and also send e-mail messages. Since such messages may be classed as data messages then other messages can be sent over-the-air by one station to another for the purpose of programming or activating facilities provided in say the secondary stations.

The primary station PS comprises a processor 10 which operates in accordance with software stored in a program memory 12. The processor 10 carries out numerous functions including message coding/decoding, message formatting and providing details of an intended addressee of a message. A transceiver 14, which may be geographically separate from the processor 10, is coupled to the processor. An interface stage 16 is coupled on the one hand to the processor 10 and on the other hand to say an internet gateway 18 to which a plurality of e-mail terminals 20A, 20B are connected and/or to the PSTN to which a telephone 21 is connected.

The secondary station SS1 comprises a processor 22 which operates in accordance with a program stored in a program store 24. The processor 22 is able to function as a codec for coding messages to be transmitted by a transceiver 26 and decoding received messages. Also coupled to the processor 22 are a keypad 28 which constitutes a man/machine interface, a LCD display panel with driver 30, a store 32 for storing melodies and a loudspeaker 34 including a tone generator (not shown) which functions as a ringer.

By a secondary station being able to store several melodic sequences or melodies not only can a user choose which of the melodic sequences is to be used as an alert but also a user can receive an audible indication that he or she has navigated to a certain item using a user interface. In a variant the melody description has been designated a tag in what is known as HDML (Handheld Device Markup Language) which will allow mobile services to be designed that contain simple melodies. Once a user has navigated to a certain item then a melodic sequence or melody can be played.

The melodic sequences can be entered into the store by the user using the keypad 28 or over-the-air from say an e-mail terminal 20A, 20B or the numeric keypad of the telephone 21. Irrespective of the precise method of entry, the method of storing the data is the same. The melodic sequences or melodies use a digital format, such as ASCII, for defining melodies which consist of notes, durations, pauses and repeats. Such a format can be used for playback on a tone generator of a cellular/cordless telephone or any other device having an audio capability.

As an example, like audio data is an unstructured string of ASCII characters which define a melody to be played by the loudspeaker (or ringer) 34. The general format is “note, duration, note, duration, and so on”. All notes are specified by two characters and durations are similarly specified. Thus a string of notes and durations comprises “xxyyxxyyxxyy—and so on”, where xx is a 2 digit note in the range from 02 to 47 and yy is a duration expressed as multiple of a standard unit of time, for example 10 ms, in the range from 00 to 99. Thus if yy equals 50, the duration is 10 ms×50 which equals 500 ms.

In extensions of this basic concept, if xx is 00 then a silence is played for a period defined by yy. It may be the case that a secondary station has already been pre-programmed during its manufacture with some melodies with each one given an identity outside the range of pairs of characters identifying individual notes. Thus if for example xx is greater than 50, the processor 22 will recognise that it has to play a pre-stored melody. A first melody, Melody 1, may be given the number 51 and a second melody, Melody 2, may be given the number 52.

In another extension, it is possible to store an instruction to repeat a sequence of notes by entering a repetition value after the relevant notes. The repetition value in an example comprises the ASCII representation of an escape character, for example a punctuation mark, such as a comma, and two pairs of characters such as aa representing the number of repeats and bb is the offset note back into the melody. The string of characters will look something like xxyyxxyyxxyy,aabb. As an example if aa is 03 and bb is 04, the melody will go back four notes and play that sequence of four notes 3 times and then carry on. In a variant, the use of an escape character can be avoided if non-pre-allocated pairs of characters are assigned to represent different values of aa and bb. This could be made possible if the duration range is shortened to say 00 to 79 or less and perhaps non-linear mapping of the pairs of characters is employed.

In a further extension, provision can be made to allow multiple repeat statements in a melody description. In implementing this extension it is assumed that repeats are always the same number of bytes, for example 4, so that there is no need for an end-of-repeat separator. A multiple repeat statement can be indicated by the ASCII representation of an escape character such as a comma, as shown in the following example: 1020, 030110211022,0202.

If the secondary station SS1 has an audio capability permitting the volume of the reproduced melodic information to be varied, then a volume indicator may be included in the string of characters. The volume indicator may apply to all or part of the reproduction of the melodic information by the loud speaker 34. In one embodiment the volume indicator comprises an escape character such as a comma followed by a two digit number having a value between 01 and 10 representing the minimum and maximum volumes for example 04. In a second embodiment the volume indicator comprises a four digit byte of which the first two digits comprise a non pre-allocated number, say 10, representing that the byte is a volume indicator, and the second two digits indicate the volume setting, for example 01 for low volume through to 10 for high volume, for example 0105.

Although the remote signalling of the melodic information is described in terms of a radio link, other means of relaying data, such as an optical fibre or infra-red radiation, may be used.

Other character sets besides ASCII may be used, for example hexadecimal.

In the present specification and claims the word “a” or “an” preceding an element does not exclude the presence of a plurality of such elements. Further, the word “comprising” does not exclude the presence of other elements or steps than those listed.

From reading the present disclosure, other modifications will be apparent to persons skilled in the art. Such modifications may involve other features which are already known in the design, manufacture and use of devices having an audio capability and component parts therefor and which may be used instead of or in addition to features already described herein. Although claims have been formulated in this application to particular combinations of features, it should be understood that the scope of the disclosure of the present application also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

1. A method of entering melodic information into a terminal having an audio capability, comprising entering the information as a string of characters representing notes and their respective durations.

2. A method as claimed in claim 1, wherein the information is transferred to the terminal from a remote terminal.

3. A method as claimed in claim 1 or 2, characterised in that a note and its duration are encoded using an equal number of characters which are concatenated to form a byte.

4. A method as claimed in claim 1 or 2, characterised by signalling a repeat of a sequence of notes by the presence of an escape character together with characters indicating the number of repeats.

5. A method as claimed in claim 4, characterised by signalling multiples of a repeat sequence of notes by the presence of an escape character.

6. A method as claimed in claim 1 or 2, characterised in that a note is indicated digitally by a pair of characters selected from a predetermined range of pairs of characters.

7. A method as claimed in claim 6, characterised in that a silence is indicated by the transmission of a pair of characters other than those in the said predetermined range.

8. A method as claimed in claim 6, characterised in that the terminal stores a plurality of melodies and in that the selection of a predetermined one of the stored melodies is done by a remote station transmitting a predetermined pair of characters other than those in the said predetermined range.

9. A method as claimed in claim 1 or 2, characterised in that a duration is indicated digitally as a multiple of a basic time element.

10. A method as claimed in claim 1 or 2, characterised by including volume indicating characters in the string of characters.

11. A method as claimed in claim 1 or 2, characterised in that the characters are ASCII characters.

12. A terminal including means providing an audio capability and storage means for storing melodic information as a string of characters representing notes and their respective durations.

13. A terminal as claimed in claim 12, characterised in that the characters are stored as ASCII characters.

14. A terminal as claimed in claim 12 or 13, characterised by means for manually entering the characters.

15. A terminal as claimed in claim 12 or 13, characterised by means for receiving external signals containing the characters and means for recovering the characters from the external signals and supplying the recovered characters to the storage means.
